(19) United States
(12) Patent Application Publication
(10) Pub. No.: US 2023/0152207 A1
(43) Pub. Date: May 18, 2023

(54) OPTICAL IMAGING SYSTEM

(71) Applicant: FlowVIEW Tek, Taipei City (TW)

(72) Inventor: Min-Chuan Shih, Taipei City (TW)

(73) Assignee: FlowVIEW Tek, Taipei City (TW)

(21) Appl. No.: 17/955,559

(22) Filed: Sep. 29, 2022

(30) Foreign Application Priority Data
Nov. 12, 2021 (TW) 110142179

(51) Int. Cl. G01N 15/14; G02B 27/30; G02B 13/22; G02B 27/28

(52) U.S. Cl. CPC G01N 15/1434; G02B 27/30; G02B 13/22; G02B 27/281; G01N 15/1404; G01N 2015/144

(57) ABSTRACT

Provided is an optical imaging system, adapted for presenting an image of a particle. The optical imaging system includes a collimated light source, a flow channel, and a telecentric lens. The collimated light source is adapted for emitting a parallel beam. The flow channel is arranged on the transmission path of the parallel beam and is adapted for allowing the particle to pass through. The telecentric lens is arranged on the transmission path of the parallel beam. The parallel beam passes through the flow channel before transmitted to the telecentric lens, and the telecentric lens is adapted for converging the parallel beam onto an imaging plane.

### CROSS-REFERENCE TO RELATED APPLICATION

This application claims the priority benefit of Taiwan application serial no. 110142179, filed on Nov. 12, 2021. The entirety of the above-mentioned patent application is hereby incorporated by reference herein and made a part of this specification.

### BACKGROUND

### Technical Field

The disclosure relates to an optical system, and more particularly to an optical imaging system.

### Description of Related Art

Requirements for application of fluid sample inspection take place in various fields, such as the biomedical and pharmaceutical industry, the semiconductor industry, the environmental engineering industry, and the like. Fluid image observers may be used to observe and photograph the information of samples flowing in a flow channel. However, the existing fluid image observers, with depth of field becoming shallower as magnification increases, are prone to cause images of the samples in the flow channel to be clear only on a focusing plane, and the samples not on the focusing plane can merely be presented by blurred images, which leads statistical data of sample analysis to be inaccurate.

### SUMMARY

The disclosure provides an optical imaging system that may make an image of a particle in a flow channel clearer and may enable the information of the particle in the flow channel to be counted and analyzed more accurately.

An embodiment of the disclosure provides an optical imaging system adapted for presenting an image of a particle. The optical imaging system includes a collimated light source, a flow channel, and a telecentric lens. The collimated light source is adapted for emitting a parallel beam. The flow channel is arranged on the transmission path of the parallel beam and is adapted for allowing the particle to pass through. The telecentric lens is arranged on the transmission path of the parallel beam. The parallel beam passes through the flow channel before transmitted to the telecentric lens, and the telecentric lens is adapted for converging the parallel beam onto an imaging plane.

The optical imaging system in the embodiments of the disclosure, with the collimated light source and the telecentric lens, projects the parallel beam onto the flow channel and makes the parallel beam pass through the flow channel before imaged by the telecentric lens, which may improve the depth of field of the optical imaging system and make the image of the particle in the flow channel clearer. In addition, the optical imaging system of the disclosure may further reduce the impact of particle positions on image magnification, which enables the information of the particle in the flow channel to be counted and analyzed more accurately.

### BRIEF DESCRIPTION OF THE DRAWINGS

FIG. 1 is a schematic diagram of an optical imaging system according to an embodiment of the disclosure.

FIG. 2 is a partial schematic diagram of the optical imaging system according to the embodiment in FIG. 1.

FIG. 3 is a schematic diagram of a collimated light source according to an embodiment of the disclosure.

FIG. 4 is a schematic diagram of a collimated light source according to another embodiment of the disclosure.

FIG. 5 is a schematic diagram of a collimated light source according to an embodiment of the disclosure.

FIG. 6A is a schematic diagram of particles and a parallel beam according to an embodiment of the disclosure.

FIG. 6B is a schematic diagram of particle images according to the embodiment of FIG. 6A.

### DESCRIPTION OF THE EMBODIMENTS

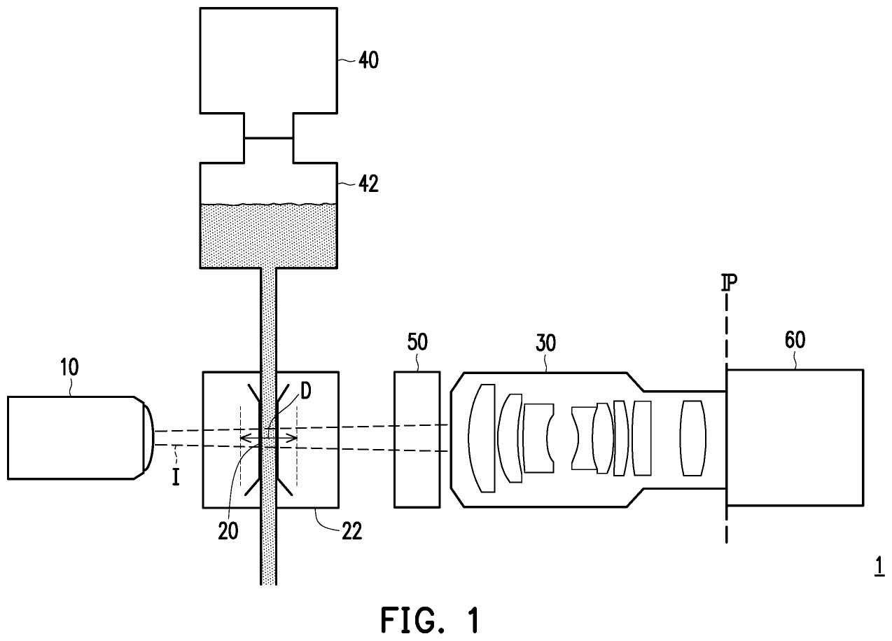

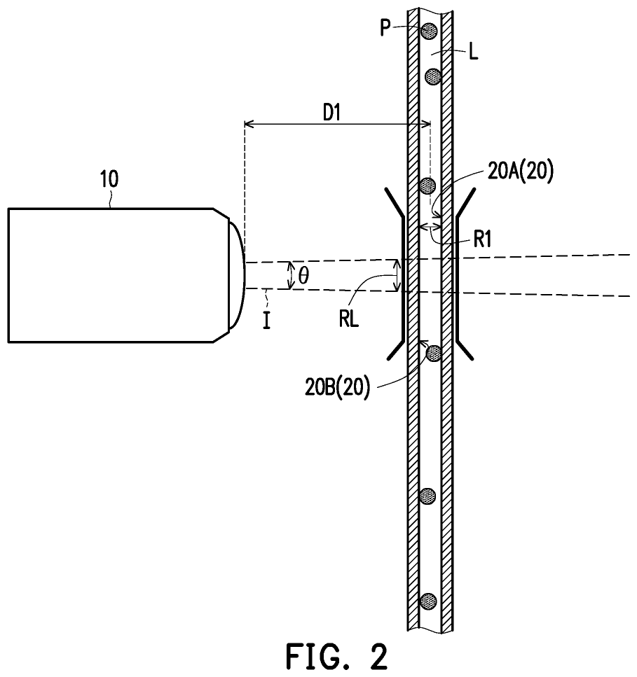

FIG. 1 is a schematic diagram of an optical imaging system according to an embodiment of the disclosure. FIG. 2 is a partial schematic diagram of the optical imaging system according to the embodiment in FIG. 1. With reference to FIG. 1 and FIG. 2, an optical imaging system 1 of the disclosure is adapted for presenting an image of a particle P in a flow channel 20. The particle P may be mixed in fluid L. In some embodiments, the particle P is a sample to be tested, such as bacteria, a semiconductor particle, particles of various materials, or the like. In another some embodiments, the particle P and the fluid L together serve as the sample to be tested, such as blood, industrial wastewater, various solutions, or the like, but the disclosure is not limited thereto. In this embodiment, the optical imaging system 1 includes a collimated light source 10, the flow channel 20, and a telecentric lens 30. The collimated light source 10 is adapted for emitting a parallel beam I. The parallel beam I refers to a beam whose waveform is substantially a plane wave and whose wavefront plane is substantially orthogonal to the direction in which the beam travels. The embodiments of the disclosure use the parallel beam I to irradiate the particle P to reduce diffraction and obtain a clearer image.

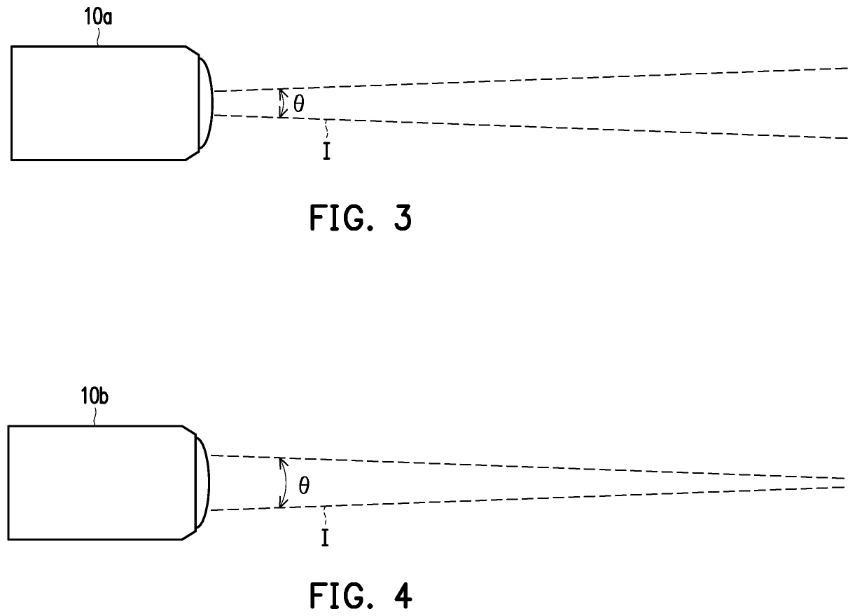

From another point of view, the parallel beam I in the embodiments of the disclosure may include substantially parallel beams whose beam angle θ ranges from −5 degrees to 5 degrees. The beam angle of the parallel beam I, defined according to the meaning known to those skilled in the art, refers to an included angle formed by two boundary lines where beam intensity is 50% of that at a beam centerline as viewed from a tangent plane through an optical axis. FIG. 3 is a schematic diagram of a collimated light source according to an embodiment of the disclosure. FIG. 4 is a schematic diagram of a collimated light source according to another embodiment of the disclosure. With reference to FIG. 3, in this embodiment, a collimated light source 10a is adapted for emitting the parallel beam I with the beam angle θ of 5 degrees, and two boundary lines of the parallel beam I (as shown in FIG. 3) form an included angle of 5 degrees. With reference to FIG. 4, in this embodiment, a collimated light source 10b is adapted for emitting the parallel beam I with the beam angle θ of −5 degrees, and two boundary lines of the parallel beam I (as shown in FIG. 4) form an included angle of −5 degrees.

With reference to FIG. 1 and FIG. 2 again, the flow channel 20 is adapted for allowing the particle P to pass through. In detail, the flow channel 20 is adapted for allowing the mixture of the fluid L and the particle P to flow from an end 20A of the flow channel 20 to an end 20B of the flow channel 20. In some embodiments, the size of the particle P ranges from 1 micrometer to 100 micrometers, but the disclosure is not limited thereto. In some embodiments, the flow channel 20 may be a micro flow channel. For example, an inner diameter R1 of the flow channel 20 may range from 0.1 millimeter to 1 millimeter, but the disclosure is not limited thereto. The flow channel 20 may be arranged on a microfluidic chip 22, but the disclosure is not limited thereto.

The flow channel 20 is arranged on the transmission path of the parallel beam I. The flow channel 20 may be made of a light-transmitting material, such that the parallel beam I may pass through the wall of the flow channel 20 and the fluid L in the flow channel 20 to be transmitted to the telecentric lens 30. The disclosure does not limit the types and light transmittance of the light-transmitting material. In some embodiments, the flow channel 20 and the collimated light source 10b are arranged to make the included angle between the parallel beam I and the flow channel 20 fall within a range from −5 degrees to 5 degrees, and the included angle may be defined by the beam centerline of the parallel beam I and the centerline of the flow channel 20. In this embodiment, the parallel beam I is substantially orthogonal to the flow channel 20. In other words, the beam centerline of the parallel beam I may be substantially orthogonal to the centerline of the flow channel 20 to obtain a better image.

In some embodiments, the collimated light source 10 and the flow channel 20 are arranged to make a distance D1 between the collimated light source 10 and the flow channel 20 fall within a range from 100 millimeters to 500 millimeters, but the disclosure is not limited thereto. A beam diameter RL of the parallel beam I at the flow channel 20 may be greater than the inner diameter of the flow channel 20. In this case, the parallel beam I may provide sufficient illumination for the particle P flowing through the flow channel 20. The beam diameter may be defined according to the meaning known to those skilled in the art to refer to, for example, a spot diameter at where light intensity is 1/e² of peak intensity. In some embodiments, the beam diameter RL of the parallel beam I at the flow channel 20 ranges from 10 millimeters to 80 millimeters to provide more homogeneous illumination, but the disclosure is not limited thereto.

The telecentric lens 30 is arranged on the transmission path of the parallel beam I. After passing through the flow channel 20 and the fluid L in the flow channel 20, the parallel beam I is transmitted to the telecentric lens 30. The telecentric lens 30 is adapted for converging and imaging the parallel beam I onto an imaging plane IP after the parallel beam I passes through the flow channel 20. Therefore, the image of the particle P may be presented on the imaging plane IP. The telecentric lens 30 has a depth of field D. In some embodiments, the flow channel 20 and the telecentric lens 30 are configured for the portion of the flow channel 20 irradiated by the parallel beam I to be located within the depth of field D of the telecentric lens 30. With this configuration, all the particles P passing through the flow channel 20 may be presented by clear images on the imaging plane IP. Generally speaking, the telecentric lens 30 may have the greater depth of field D to provide clearer images. In some embodiments, the effective focal length of the telecentric lens 30 may range from 144 micrometers to 216 micrometers, but the disclosure is not limited thereto.

In this embodiment, the optical imaging system 1 may further include a fluid pump 40 and a containing cavity 42. The containing cavity 42 is in fluid communication with the flow channel 20. The containing cavity 42 contains the fluid L and the particle P to be tested. The fluid pump 40 is connected with the containing cavity 42 and is adapted for driving the fluid L, such that the mixture of the fluid L and the particle P flows from the containing cavity 42 to the flow channel 20, and the fluid L and the particle P pass through the flow channel 20. The fluid pump 40 may be a mechanical micro pump or a non-mechanical micro pump, but the disclosure is not limited thereto. In some embodiments, with the fluid pump 40 in cooperation with the flow channel 20, the flow rate of the fluid L ranges from 0.3 ml/min to 3 ml/min, but the disclosure is not limited thereto.

In this embodiment, the optical imaging system 1 may further include a circular polarizer 50. The circular polarizer 50 may include a quarter-wave plate and a linear polarizer. In this embodiment, the circular polarizer 50 is arranged on the transmission path of the parallel beam I, and the circular polarizer 50 may be arranged between the flow channel 20 and the telecentric lens 30, such that the parallel beam I is transmitted to the telecentric lens 30 through the circular polarizer 50 after passing through the flow channel 20. The quarter-wave plate may be, for example, arranged between the linear polarizer and the telecentric lens 30. The circular polarizer 50 may filter out some stray light (such as ambient light reflected by the wall of the flow channel 20) to reduce the impact of the ambient light and improve image quality.

In this embodiment, the optical imaging system 1 may further include an image sensing apparatus 60, arranged on the imaging plane IP. The image sensing apparatus 60 may include a charge-coupled device (CCD) or a complementary metal oxide semiconductor (CMOS). The image sensing apparatus 60 may further convert the image of the particle P on the imaging plane IP to an electronic signal.

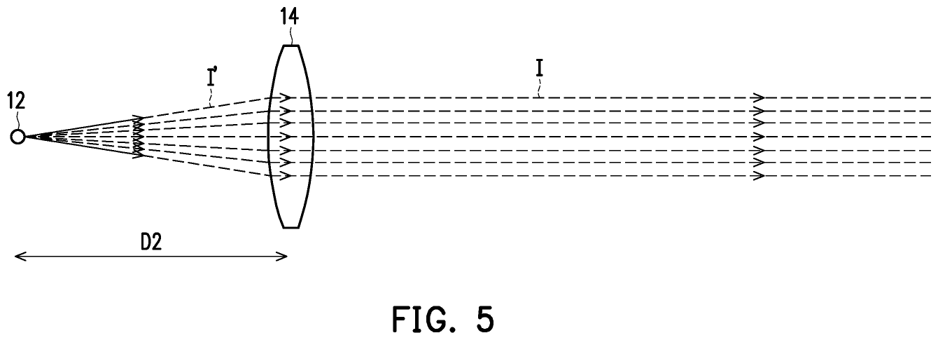

FIG. 5 is a schematic diagram of a collimated light source according to an embodiment of the disclosure. With reference to FIG. 5, in this embodiment, the collimated light source 10 includes a point light source 12 and a collimated lens 14. The point light source 12 may include one or more high-power light-emitting diode devices, but the disclosure is not limited thereto. As shown in FIG. 5, in this embodiment, the point light source 12 may emit a divergent beam I′. The collimated lens 14 may be a single convex lens or a combination of multiple lenses. A distance D2 between the point light source 12 and the collimated lens 14 may be configured to be substantially the same as an effective focal length f of the collimated lens 14, such that the divergent beam I′ emitted by the point light source 12 may be collimated by the collimated lens 14 to obtain the parallel beam I.

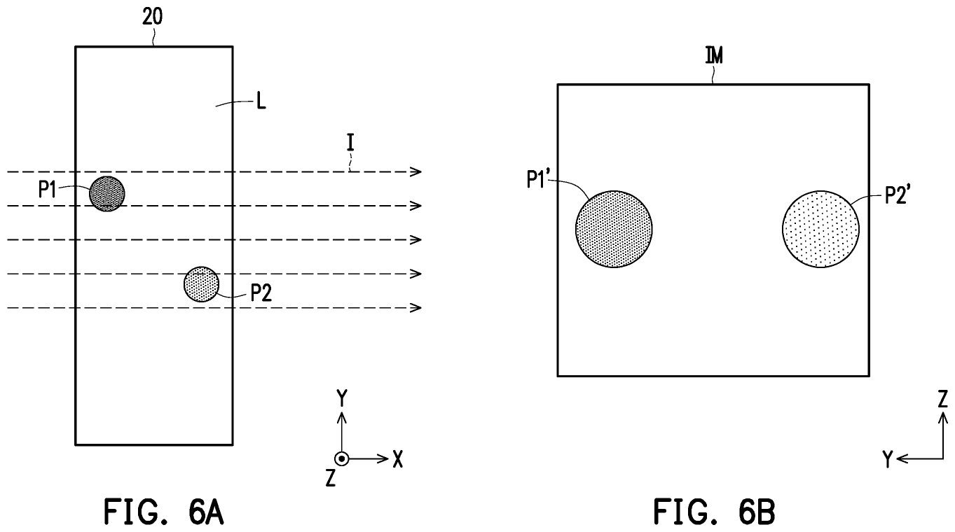

FIG. 6A is a schematic diagram of particles and a parallel beam according to an embodiment of the disclosure. FIG. 6B is a schematic diagram of particle images according to the embodiment of FIG. 6A. With reference to FIG. 6A and FIG. 6B, as shown in FIG. 6A, a first particle P1 and a second particle P2 pass through the portion of the flow channel 20 irradiated by the parallel beam I. The first particle P1 is located on the side closer to the collimated light source 10 in the flow channel 20, and the second particle P2 is located on the side farther from the collimated light source 10 in the flow channel 20. The parallel beam I irradiating the first particle P1 and the second particle P2 passes through the fluid L in the flow channel 20 and the flow channel 20 before transmitted to the telecentric lens 30. Afterwards, the parallel beam I is converged onto the image sensing apparatus 60 through the telecentric lens 30 to form an image IM shown in FIG. 6B.

The image IM includes a first particle image P1′ and a second particle image P2′. The first particle image P1′ is an optical image corresponding to the first particle P1, while the second particle image P2′ is an optical image corresponding to the second particle P2. Magnification M1 of the first particle image P1′ is similar to magnification M2 of the second particle image P2′. For example, the ratio of the magnification M1 of the first particle image P1′ to the magnification M2 of the second particle image P2′ may range from 1 to 1.0358, but the disclosure is not limited thereto. In this embodiment, the magnification M1 of the first particle image P1′ is substantially the same as the magnification M2 of the second particle image P2′. Therefore, the first particle image P1′ and the second particle image P2′ may present the size relationship between the first particle P1 and the second particle P2 in a more accurately way. For example, if the size of the first particle P1 and the size of the second particle P2 are substantially the same, then the size of the first particle image P1′ and the size of the second particle image P2′ are also substantially the same, regardless of where the first particle P1 and the second particle P2 are located in the flow channel 20. Therefore, the optical imaging system 1 of the disclosure may analyze a particle and measure the particle size more accurately. The magnification M1 of the first particle image P1′ and the magnification M2 of the second particle image P2′ may fall within a range from 3.8447 to 3.982253, but the disclosure is not limited thereto.

In summary, the optical imaging system of the disclosure, with the collimated light source and the telecentric lens, projects the parallel beam onto the flow channel and makes the parallel beam pass through the flow channel before imaged by the telecentric lens, which may improve the depth of field of the optical imaging system and make the image of the particle in the flow channel clearer. In addition, the optical imaging system of the disclosure may further reduce the impact of particle positions on image magnification, which enables the information of the particle in the flow channel to be counted and analyzed more accurately.

What is claimed is:

1. An optical imaging system, adapted for presenting an image of a particle, the optical imaging system comprising:
a collimated light source, adapted for emitting a parallel beam;
a flow channel, arranged on a transmission path of the parallel beam and adapted for allowing the particle to pass through; and
a telecentric lens, arranged on the transmission path of the parallel beam, wherein the parallel beam passes through the flow channel before transmitted to the telecentric lens, and the telecentric lens is adapted for converging the parallel beam onto an imaging plane.

2. The optical imaging system according to claim 1, wherein a beam angle of the parallel beam ranges from −5 degrees to 5 degrees.

3. The optical imaging system according to claim 1, wherein the collimated light source comprises a point light source and a collimated lens.

4. The optical imaging system according to claim 1, wherein an included angle between the parallel beam and the flow channel ranges from −5 degrees to 5 degrees.

5. The optical imaging system according to claim 1, wherein a portion of the flow channel irradiated by the parallel beam is located within a depth of field of the telecentric lens.

6. The optical imaging system according to claim 1, wherein a beam diameter of the parallel beam at the flow channel is greater than an inner diameter of the flow channel.

7. The optical imaging system according to claim 1, wherein a beam diameter of the parallel beam at the flow channel ranges from 10 millimeters to 80 millimeters.

8. The optical imaging system according to claim 1, wherein an inner diameter of the flow channel ranges from 0.1 millimeter to 1 millimeter.

9. The optical imaging system according to claim 1, wherein a distance between the collimated light source and the flow channel ranges from 100 millimeters to 500 millimeters.

10. The optical imaging system according to claim 1, wherein the optical imaging system further comprises a circular polarizer, arranged on the transmission path of the parallel beam, and the parallel beam passes through the flow channel before transmitted to the telecentric lens through the circular polarizer.

11. The optical imaging system according to claim 1, wherein the particle is mixed in fluid, and the optical imaging system further comprises a fluid pump, adapted for driving the fluid for the particle to pass through the flow channel.

12. The optical imaging system according to claim 10, wherein the fluid pump cooperates with the flow channel so that a flow rate of the fluid ranges from 0.3 ml/min to 3 ml/min.

13. The optical imaging system according to claim 1, wherein a size of the particle ranges from 1 micrometer to 100 micrometers.

14. The optical imaging system according to claim 1, wherein the optical imaging system further comprises an image sensing apparatus arranged on the imaging plane.
